(19) United States
(12) Patent Application Publication
(10) Pub. No.: US 2008/0158291 A1
(43) Pub. Date: Jul. 3, 2008

(54) Method of cleaning ink discharge portion, and cleaning device and image forming device

(75) Inventor: Kenichi SATAKE, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/947,370

(22) Filed: Nov. 29, 2007

(30) Foreign Application Priority Data
Dec. 27, 2006 (JP) JP 2006-351169

(51) Int. Cl. B41J 2/165

(52) U.S. Cl. 347/33

(57) ABSTRACT

An object of the present invention is to inhibit a decrease in cleaning efficiency when the amount of ink discharged from the ink discharge portion is increased. A method of cleaning an ink discharge portion of an inkjet printer includes a scraping-away-ink step, a cleaning step with water, and scraping-away-fluid step. The inkjet printer includes the ink discharge portion that is formed to extend in a direction and includes an ink discharge surface being capable of discharging ink. The inkjet printer is also capable of forming an image on media by discharging the ink on the media by way of the ink discharge portion. Here, the scraping-away-ink step is a step of scraping away the ink adhering to the surface of the ink discharge portion. The cleaning step with water is a step of cleaning the surface of the ink discharge portion with water. The scraping-away-fluid step is a step of scraping away the fluid adhering to the surface of the ink discharge portion after the surface of the ink discharge portion is cleaned in the cleaning step with water.

### CROSS-REFERENCE TO RELATED APPLICATIONS

This application claims priority to Japanese Patent Application No. 2006-351169 (filed Dec. 27, 2006), the entirety of which is hereby incorporated by reference in its entirety.

### BACKGROUND OF THE INVENTION

### Field of the Invention

The present invention relates to a method of cleaning an ink discharge portion of an image forming device, and also relates to a cleaning device and an image forming device. Some image forming devices, such as an inkjet color printer, employ a system by which an image is formed on a sheet of paper functioning as a recording media by jetting an ink. This type of image forming device includes an image forming unit that is capable of forming an image, a paper loading unit into which a single or plurality of sheets of paper on which an image is to be formed is loaded, a paper conveyor unit that conveys a sheet of paper to the image forming unit, and a paper discharge unit that is capable of discharging a sheet of paper after an image is formed on the sheet of paper. In the image forming device, a sheet of paper loaded into the paper loading unit is conveyed to the image forming unit, and an image is formed on the sheet of paper based on image information. After the image is formed on the sheet of paper by the image forming unit, the sheet of paper is transported to the paper discharging unit and is then discharged outside.

Japan Patent Application Publication JP-A-2002-361879 disclosed an image forming unit that includes an ink discharge portion that is capable of discharging an ink on a sheet of paper, and a cleaning unit that cleans the ink discharge portion. When an image forming operation is performed, ink is discharged onto a sheet of paper from the ink discharge portion, and then the ink discharge portion is cleaned by the cleaning unit. The cleaning unit includes a cleaning blade that is made of an elastic member, and a porous elastic member into which fluid is absorbed. In the cleaning unit, ink remaining on the surface of the ink discharge portion is absorbed by the porous elastic member when a cleaning operation is performed, and then the surface of the ink discharge portion is wiped out by the cleaning blade.

In the above described cleaning unit, the ink adhering to the surface of the ink discharge portion is absorbed by the porous elastic member, and then the surface of the ink discharge portion is wiped out by the cleaning blade. In other words, moisture/fluid adhering to the ink discharge portion is scraped away. However, when the amount of ink discharged from the ink discharge portion is increased and exceeds the maximum absorption by the porous elastic member, the moistened porous elastic member cannot completely absorb the ink. Accordingly, cleaning efficiency is negatively affected. When cleaning efficiency is decreased, the ink adhering to the ink discharge portion will dry and the water-shedding property of the ink discharge portion will decrease. When the water-shedding property of the ink discharge portion decreases in this way, image quality accordingly decreases.

### SUMMARY OF THE INVENTION

An object of the present invention is to inhibit a decrease in cleaning efficiency when the amount of ink discharged from the ink discharge portion is increased.

A method of cleaning an ink discharge portion in accordance with an aspect of the present invention is a method of cleaning an ink discharge portion of an image forming device that is capable of forming an image on media by discharging an ink on the media by way of the ink discharge portion formed to extend in a direction, and includes a scraping-away-ink step, a cleaning step with water, and a scraping-away-fluid step. The scraping-away-ink step is a step for scraping away ink adhering to a surface of the ink discharge portion. The cleaning step with water is a step for cleaning the surface of the ink discharge portion with water. The scraping-away-fluid step is a step for scraping away fluid adhering to the surface of the ink discharge portion after the ink discharge portion is cleaned in the cleaning step with water.

In the method of cleaning the ink discharge portion, the ink adhering to the surface of the ink discharge portion is scraped away, and then the ink discharge portion is cleaned with water. After this, the fluid adhering to the ink discharge portion is scraped away.

Here, the ink discharge portion is cleaned with water after the ink adhering to the surface of the ink discharge portion is scraped away. Accordingly, it is possible to prevent a decrease in cleaning efficiency when the amount of ink discharged from the ink discharge portion is increased.

A cleaning device for an ink discharge portion of an image forming device in accordance with another aspect of the present invention is a cleaning device that is movably provided in the image forming device capable of forming an image on media by discharging an ink on the media by way of the ink discharge portion, which is formed to extend in a direction and includes an ink discharge surface capable of discharging the ink, and includes a first blade member, a water roller, a second blade member, and a housing. The first blade member is a member capable of making contact with the ink discharge surface. The water roller is a roller including a first porous member on the surface thereof, and water is absorbed in the first porous member. The second blade member is a member capable of making contact with the ink discharge surface. The housing accommodates the first blade member, the water roller, and the second blade member such that the first blade member, the water roller, and the second blade member are sequentially arranged along a moving direction, and supports the first blade member, the water roller, and the second blade member.

In the cleaning device for cleaning the ink discharge portion, when a cleaning operation is performed with respect to the ink discharge portion, the housing is caused to move while the first blade member makes contact with the ink discharge surface of the ink discharge portion. In addition to the first blade member, the water roller and the second blade member are also herein caused to move. During the movement of the water roller and the second blade member, the water roller and the second blade member make contact with the ink discharge portion sequentially in this order, and thus the ink discharge surface is cleaned.

Here, during the movement of the housing, the first blade member, the water roller, and the second blade member are sequentially caused to move, and thus it is possible to clean the ink discharge surface.

An image forming device in accordance with another aspect of the present invention includes an image forming unit, a cleaning unit, and a moving mechanism. The image forming unit includes an ink discharge portion having an ink discharge surface that is capable of discharging an ink, and forms an image on media by discharging the ink on the media by means of the ink discharge portion. The cleaning unit is movably disposed with respect to the ink discharge surface, and includes a first blade member that is capable of making contact with the ink discharge surface, a water roller that includes a first porous member, which is capable of absorbing moisture, on the surface thereof, a second blade member that is capable of making contact with the ink discharge surface, and a housing that accommodates the first blade member, the water roller, and the second blade member such that the first blade member, the water roller, and the second blade member are sequentially disposed along a moving direction, and supports the first blade member, the water roller, and the second blade member. The moving mechanism moves the cleaning unit along the ink discharge surface from the first blade member side.

In the image forming device, when a cleaning operation is performed with respect to the ink discharge portion, the cleaning device moves along the ink discharge surface while the first blade member makes contact with the ink discharge surface of the ink discharge portion. In addition to the first blade member, the water roller and the second blade member are also herein caused to move on the ink discharge surface. During the movement of the water roller and the second blade member, the water roller and the second blade member make contact with the ink discharge portion sequentially in this order, and thus the ink discharge surface is cleaned.

Here, when the cleaning device moves, the first blade member, the water roller, and the second blade member are caused to move on the ink discharge surface, and thus it is possible to clean the ink discharge surface.

### BRIEF DESCRIPTION OF THE DRAWINGS

FIG. 1 is a schematic view illustrating an entire inkjet printer including a cleaning device according to which an embodiment of the present invention.

FIG. 2 is a view of a diagram illustrating up-and-down movement of a conveyor belt of the printer performed by an elevation device.

FIG. 3 is a top view of the entire cleaning device and its periphery.

FIG. 4 is a cross-sectional view of the entire cleaning device.

FIG. 5 is view of a diagram illustrating a configuration of a moving mechanism of the inkjet printer.

FIG. 6 is a top view of an entire cleaning device in accordance with a second embodiment of the present invention.

FIG. 7 is a cross-sectional view of the entire cleaning device in accordance with the second embodiment of the present invention.

### DETAILED DESCRIPTION OF THE PREFERRED EMBODIMENTS

### 1. First Embodiment

### 1-1. Overall Configuration

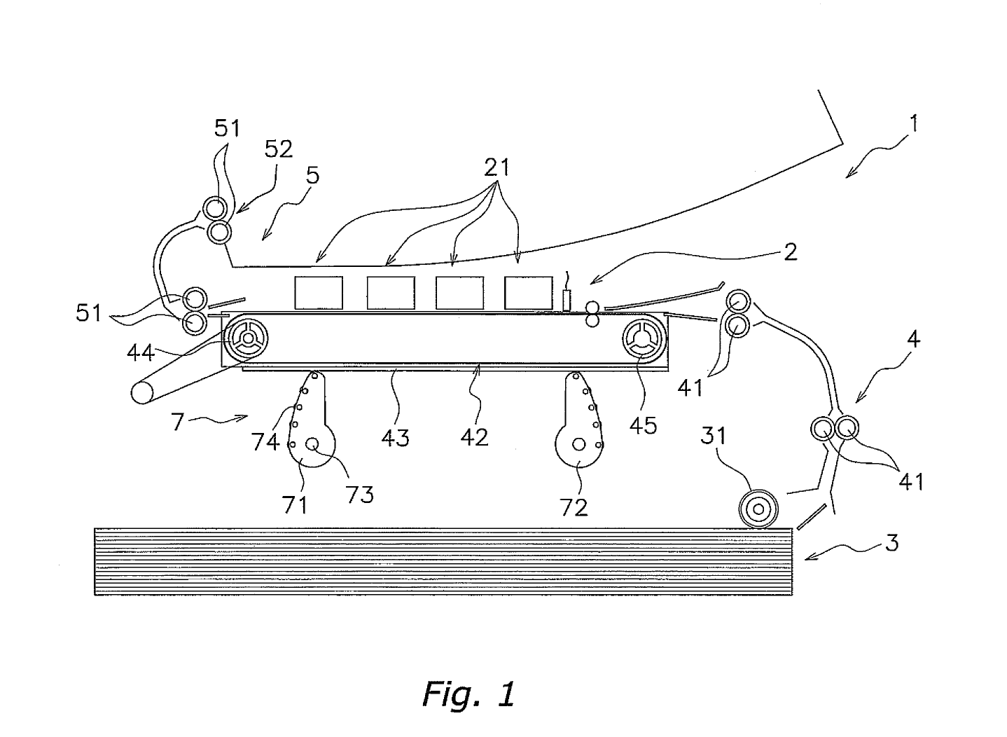

FIG. 1 illustrates an inkjet printer 1 as an example of an image forming device according to an embodiment of the present invention. FIG. 1 is a schematic front view simply illustrating a configuration of the inkjet printer 1. The inkjet printer 1 is connected to a single or plurality of external computers or the like (not illustrated in the figure), and is capable of forming an image based on image information to be outputted from the external computer(s). Also, the inkjet printer 1 includes an image forming unit 2, a paper loading unit 3, a paper conveyor unit 4, an elevation device 7, and a paper discharge unit 5. Note that ink to be used in the inkjet printer 1 is made by dispersing a pigment as a dispersoid, the surface of which is coated with a resin, into a disperse medium mainly (70-80%) including water.

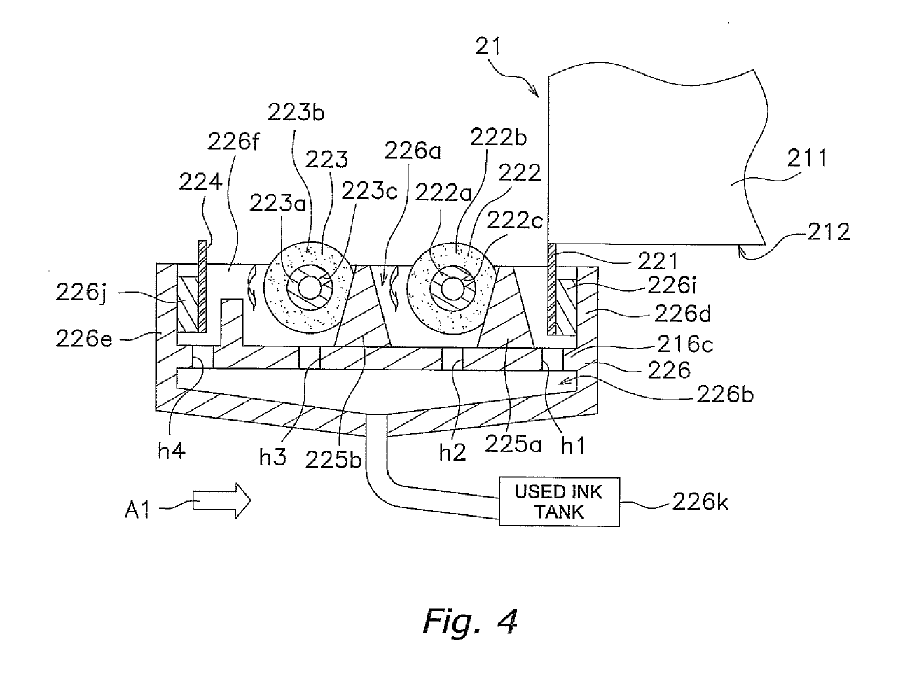

The image forming unit 2 forms an image based on the image information, and includes a single or plurality of inkjet heads 21. In this configuration, four inkjet heads 21 are disposed side-by-side above a paper conveyor belt 42 of the paper conveyor unit 4, and jet ink on a sheet of paper as media based on the image information. In addition, each of the inkjet heads 21 accommodates ink, and colors of the accommodated ink are different from each other. As illustrated in FIG. 4, each of the inkjet heads 21 includes an ink discharge portion 211 (e.g., inkjet nozzle) that is capable of discharging the accommodated ink. Furthermore, the inkjet head 21 is a substantially rectangular solid member formed to extend in a direction (i.e., direction perpendicular to the image illustrated in FIG. 1). As illustrated in FIG. 4, the ink discharge portion 211 includes an ink discharge surface 212 that is disposed to face a sheet of paper, and a plurality of holes through which ink is discharged is formed in the ink discharge portion 211 so as to be disposed side-by-side. The ink discharge surface 212 is formed in a rectangular shape, and its length in a front-to-rear direction is longer than that in a horizontal direction. Note that the term “front-to-rear direction” hereinafter means a direction perpendicular to the image illustrated in FIG. 1, and the near side and the far side in the direction perpendicular to the image illustrated in FIG. 1 are hereinafter referred to as “front side (or frontward)” and “rear side (or rearward),” respectively.

The paper loading unit 3 is capable of loading a single or plurality of sheets of paper on which an image is to be formed, and is disposed in the lower portion of the inkjet printer 1. In addition, the paper loading unit 3 includes a paper feeding roller 31 for feeding a sheet of paper to the paper conveyor unit 4. The paper feeding roller 31 is disposed above the end portion (i.e., on the paper feeding side) of the paper loading unit.

The paper conveyor unit 4 conveys a sheet of paper loaded in the paper loading unit 3 to the image forming unit 2, and also conveys the sheet of paper to the paper discharge unit 5 after an image is formed on the surface of the sheet of paper by the image forming unit 2. The paper conveyor unit 4 includes a plurality of rollers 41 for conveying a sheet of paper, and the paper conveyor belt 42. The paper conveyor belt 42 is an endless belt that is disposed below the inkjet heads 21. A roller 44 and a roller 45 are disposed to be opposed to each other on the inner peripheral side of the paper conveyor belt 42, and circulate the paper conveyor belt 42. The paper conveyor belt 42 is supported by a box-shaped belt support member 43 through the rollers 44 and 45. Here, the belt support member 43 faces the conveyor belt 42 on the front, rear, and lower sides of the paper conveyor belt 42, and upper side and both lateral sides of the belt support member 43 are opened. Note that only a portion of the belt support member 43, which is opposed to the conveyor belt 42 on the rear and lower sides, is illustrated in FIG. 1 for easy understanding of the configuration of the belt support member 43.

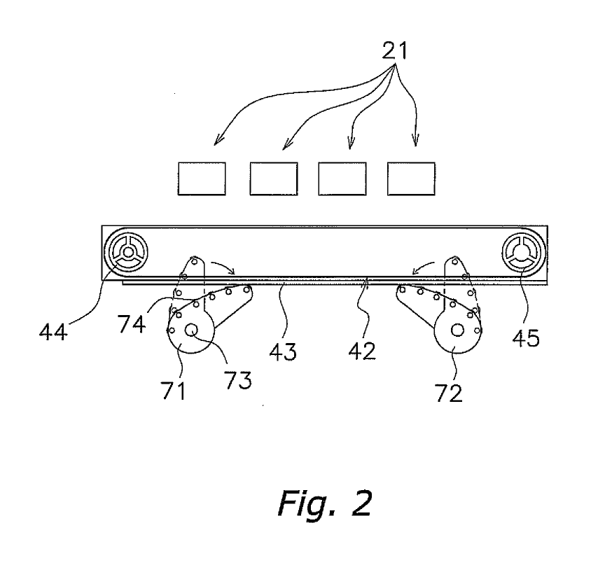

The elevation device 7 is disposed below the paper conveyor belt 42 of the paper conveyor unit 4, and moves the paper conveyor belt 42 up and down. The elevation device 7 includes a pair of eccentric cams 71 and 72. The eccentric cam 71 (hereinafter referred to as “first eccentric cam 71”), which is arranged on the left side in FIG. 1, is provided so as to be capable of rotating around a shaft 73, and is rotary-driven by way of a motor (not illustrated in the figure). The first eccentric cam 71 is provided with a plurality of bearings 74, and supports the belt support member 43 through the bearings 74. Note that in FIG. 1, only one of the plurality of bearings is given numeral 74, and the numbering of the rest of the bearings is omitted, but referred to by the same numeral. The eccentric cam 72 (hereinafter referred to as “second eccentric cam 72”), which is arranged on the right side in FIG. 1, has the same configuration as the first eccentric cam 71, and is formed in a symmetric shape to the first eccentric cam 71 in a horizontal direction in FIG. 1. FIG. 1 illustrates a condition in which the paper conveyor belt 42 is moved up. As illustrated in FIG. 2, when the pair of eccentric cams 71 and 72 rotate inward from the condition illustrated in FIG. 1, the conveyor belt 42 is moved down. When an image is formed on a sheet of paper by the image forming unit 2, the elevation device 7 keeps the paper conveyor belt 42 in the moving-up condition illustrated in FIG. 1, and a space preferred for printing (approximately 1.0 mm in the present embodiment) is generated between the sheet of paper and the inkjet heads 21. On the other hand, when a paper jam occurs on the paper conveyor belt 42 and is handled, or when a cleaning device 22 to be described performs a cleaning operation of the inkjet heads 21, the elevation device 7 keeps the paper conveyor belt 42 in the moving-down condition illustrated in FIG. 2, and enlarges the space between the sheet of paper and the inkjet heads 21.

The paper discharge unit 5 is disposed in the upper portion of the inkjet printer 1, and discharges a sheet of paper after an image is formed on the sheet of paper by the image forming unit 2. The discharge unit 5 includes a plurality of rollers 51. After an image is formed on a sheet of paper by the image forming unit 2, the sheet of paper is conveyed by means of the paper conveyor belt 42 of the paper conveyor unit 4 and rollers 51 of the discharging unit 5, and is then discharged from the paper discharge outlet 52 to the outside of the inkjet printer 1.

### 1-2. Cleaning Device Configuration

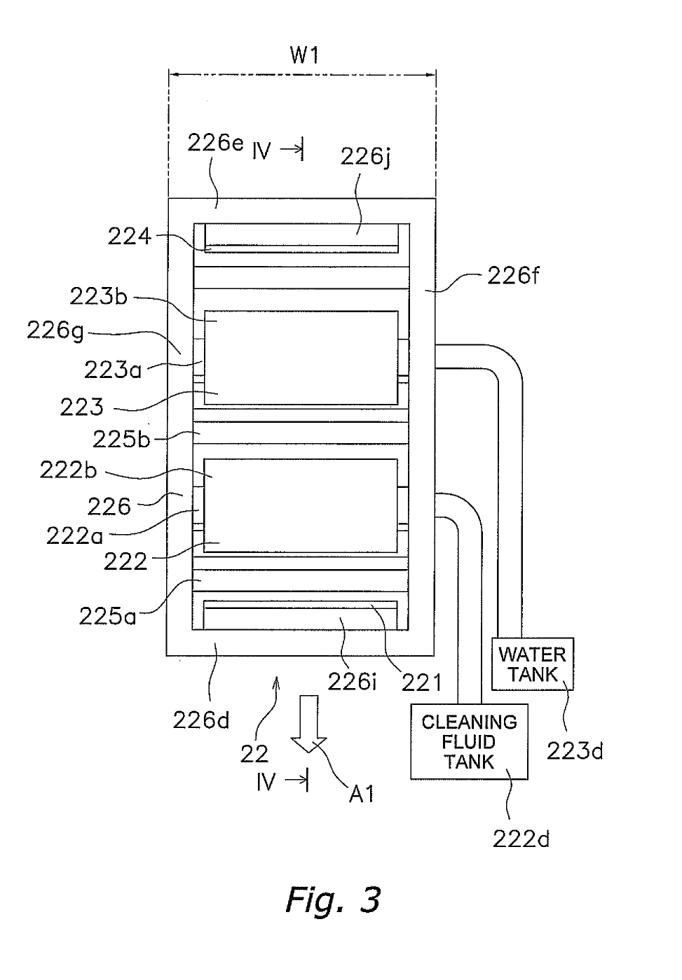

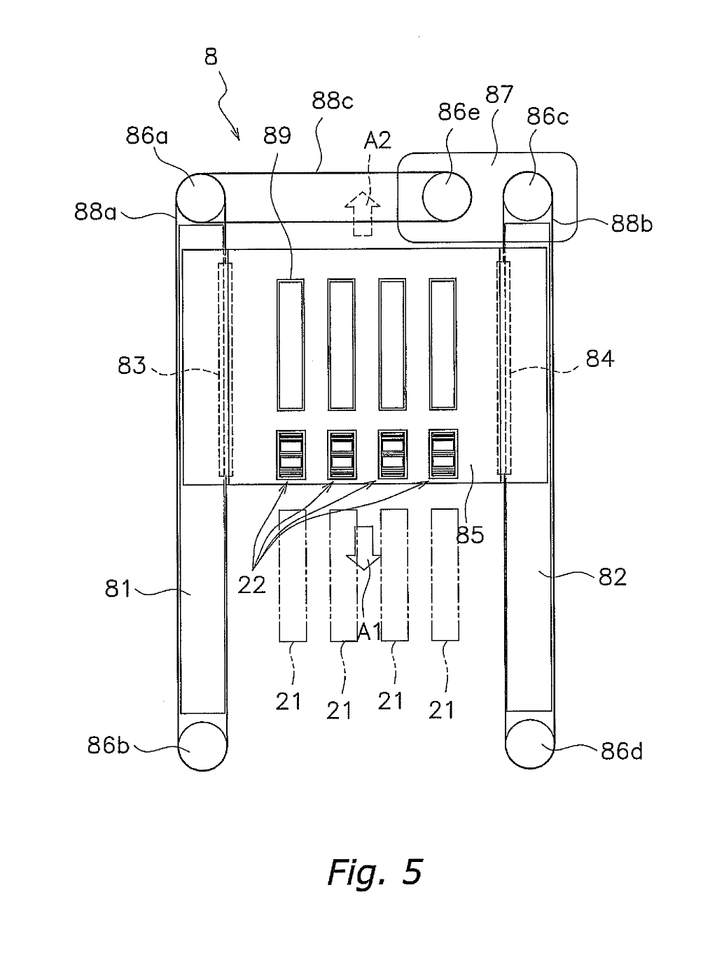

FIGS. 3 and 4 are diagrams illustrating the entire cleaning device 22. FIG. 3 is a top view of the cleaning device 22, and FIG. 4 is a lateral cross-sectional view of the cleaning device 22. The cleaning device 22 serves to clean the ink discharge surface 212, and is configured to be capable of moving in the longitudinal direction of the inkjet head 21 (i.e., direction perpendicular to the image illustrated in FIG. 1) as illustrated in Arrow A1 of FIGS. 3 and 4. Note that when an image forming operation is performed, the cleaning device 22 is retracted to the outside of the end portion of the inkjet head 21 in the longitudinal direction so as not to block ink-discharging. As illustrated in FIG. 3, the width W1 of the cleaning device 22 is larger than the width of the inkjet head 21 (i.e., horizontal length of the inkjet head 21 in FIG. 1). In addition, the cleaning device 22 is provided to correspond to each of the inkjet heads 21, and is connected to a used ink tank 226k illustrated in FIG. 4. Furthermore, the cleaning device 22 is caused to move along the ink discharge surface 212 in an Arrow A1 direction in FIG. 4 by a moving mechanism 8 illustrated in FIG. 5, and includes a first blade member 221, a cleaning fluid roller 222, a water roller 223, a second blade member 224, a regulation plate 225a, a regulation plate 225b, and a casing 226.

The first blade member 221 scrapes away the ink adhering to (or remaining on) the ink discharge surface 212, and is a plate-shaped member formed to extend in a direction (i.e., direction perpendicular to the image illustrated in FIG. 4, and in other words, the direction of the shorter length of the ink discharge surface 212). Note that the direction in which the shorter side of the rectangular-shaped ink discharge surface 212 is formed is hereinafter simply referred to as “shorter direction.” Furthermore, the first blade member 221 is formed such that its length perpendicular to the image illustrated in FIG. 4 is approximately the same as the length of the ink discharge surface 212 in the shorter direction. In addition, the first blade member 221 is disposed on the font end side of the casing 226 in a moving direction A1, and the upper tip of the first blade member 221 is disposed at a position slightly higher than the position of the ink discharge surface 212. In addition, the first blade member 221 is made of elastically deformable substance such as ethylene propylene diene monomer (EPDM) and fluoro rubber, and is disposed along the shorter direction of the ink discharge surface 212 (i.e., horizontal direction in FIG. 1).

The cleaning fluid roller 222 serves to clean the ink discharge surface 212 with cleaning fluid, and is disposed on the leftward of the first blade member 221 in FIG. 4. In other words, the cleaning fluid roller 222 is arranged sequentially next to the first blade member 221 in the moving direction A1 of the casing 226. The cleaning fluid roller 222 is formed such that its length perpendicular to the image illustrated in FIG. 4 is approximately the same as the length of the ink discharge surface 212 in the shorter direction. In addition, the cleaning fluid roller 222 includes a cleaning fluid roller rotation shaft 222a and a second porous member 222b. The cleaning fluid roller rotation shaft 222a is a hollow shaft member, and is formed to extend in a direction perpendicular to the image illustrated in FIG. 4. The cleaning fluid roller rotation shaft 222a is capable of accommodating cleaning fluid in the interior thereof and is connected to a cleaning fluid tank 222d. In addition, the cleaning fluid roller rotation shaft 222a includes a slit 222c. The slit 222c is formed to extend in an axial direction of the cleaning fluid roller 222a, and cleaning fluid is allowed to pass through the slit 222c. Note that the slit 222c is formed not to reach the both end portions of the rotation shaft. Thus, the cleaning fluid accommodated in the interior of the cleaning fluid roller rotation shaft 222a is allowed to be supplied to the second porous member 222b. Here, a plurality of small holes (i.e., pores) may be formed in the cleaning fluid roller rotation shaft 222a instead of forming the slit 222c through which the cleaning fluid passes. In addition, the cleaning fluid roller rotation shaft 222a is secured to the casing 226. The second porous member 222b is a porous member such as a sponge, which is disposed to wind around the cleaning fluid roller rotation shaft 222a. In addition, the second porous member 222b is configured to be disposed such that the highest position thereof is arranged to be approximately the same as the position of the tip of the first blade member 221. The second porous member 222b is rotatably disposed with respect to the cleaning fluid roller rotation shaft 222a, and rotates in the counterclockwise direction in FIG. 4 when the cleaning device 22 moves and thus the second porous member 222b makes contact with the ink discharge surface 212. Note that the cleaning fluid mainly includes a polyhydric alcohol and a surface active agent added as the principal ingredients in the water and that the cleaning fluid contains 60 to 80% of water and 15 to 25% of a polyhydric alcohol and a surface active agent. Glycerin, diethylene glycol, propylene glycol are preferable as polyhydric alcohol, and amongst them, glycerin is particularly preferable. Also, acethylene glycols such as nonionic surface-active agent is preferable as surface active agent, and amongst them, acethylenediol is particularly preferable. This type of cleaning fluid easily foams, and thus it is possible to enhance cleaning efficiency with the cleaning fluid. In addition, when bubbles of the cleaning fluid pass through the holes formed in the ink discharge portion 211 to discharge ink and get mixed in with the ink, it is possible to prevent the image quality from being deteriorated by easily defoaming the bubbles.

The water roller 223 serves to clean the ink discharge surface 212 with water, and is disposed on the leftward of the cleaning fluid roller 222 in FIG. 4. In other words, the water roller 223 is arranged sequentially next to the cleaning fluid roller 222 in the moving direction A1 of the casing 226. The water roller 223 is formed such that its length perpendicular to the image illustrated in FIG. 4 is approximately the same as the length of the ink discharge surface 212 in the shorter direction. In addition, the water roller 223 includes a water roller rotation shaft 223a and a first porous member 223b. The water roller rotation shaft 223a is a hollow shaft member, and is capable of accommodating water in the interior thereof. In addition, the water roller rotation shaft 223a includes a plurality of water through holes 223c that are disposed to be equally spaced apart. Thus, the water accommodated in the interior of the water roller rotation shaft 223a is allowed to be supplied to the first porous member 223b. Furthermore, the water roller rotation shaft 223a is a member formed to extend in a direction perpendicular to the image illustrated in FIG. 4. The water roller rotation shaft 223a is secured to the casing 226a and is connected to a water tank 223d illustrated in FIG. 3. The first porous member 223b is a porous member such as a sponge, which is disposed to wind around the water roller rotation shaft 223a, and is rotatably provided with respect to the water roller rotation shaft 223a. In addition, the first porous member 223b is configured to be disposed such that the highest position thereof is arranged to be approximately the same as the position of the upper tip of the first blade member 221, and rotates in the counterclockwise direction in FIG. 4 when the cleaning device 22 moves and thus the first porous member 223b makes contact with the ink discharge surface 212.

The second blade member 224 scrapes away fluid (e.g., ink, water, and cleaning fluid) adhering to the ink discharge surface 212, and is a plate-shaped member formed to extend in a direction (i.e., direction perpendicular to the image illustrated in FIG. 4). The second blade member 224 is formed such that its length perpendicular to the image illustrated in FIG. 4 is approximately the same as the length of the ink discharge surface 212 in the shorter direction. In addition, the second blade member 224 is disposed on the rear end side of the casing 226 in the moving direction A1, and the upper tip of the second blade member 224 is disposed at a position slightly higher than the position of the ink discharge surface 212. In addition, the second blade member 224 is made of elastically deformable substance such as ethylene propylene diene monomer (EPDM) and fluoro rubber.

The regulation plate 225a makes contact with a portion of the first porous member 223b of the water roller 223. On the other hand, the regulation plate 225b makes contact with a portion of the second porous member 222b of the cleaning fluid roller 222. The first and second porous members 223b and 222b are compressed when they make contact with the regulation plates 225a and 225b, respectively. Accordingly, fluids absorbed in the first and second porous members 223b and 222b are squeezed out. More specifically, when the first and second porous members 223b and 222b rotate, the portions of the first and second porous members 223b and 222b, which make contact with the ink discharge surface 212, move and make contact with the regulation plates 225a and 225b, respectively. Accordingly, the water and the cleaning fluid, both of which include the ink, are squeezed out of the first and second porous members 223b and 222b, respectively. In addition, as illustrated in FIG. 4, the regulation plates 225a and 225b are pillar members with a trapezoid-shaped cross-section, and the upper surface area of the regulation plates 225a and 225b is formed to be narrower than the lower surface area thereof.

The casing 226 is a member supporting the first blade member 221, the cleaning fluid roller 222, the water roller 223, the second blade member 224, the regulation plate 225a, and the regulation plate 225b, and includes a member arrangement part 226a and a waste collected space 226b. Here, members such as the first blade member 221 and the cleaning fluid roller 222 are arranged in the member arrangement part 226a, and wasted fluid is collected in the waste collected space 226b. The member arrangement part 226a includes a bottom portion 226c, a sidewall 226d on the first blade member side, a sidewall 226e on the second blade member side, a first sidewall 226f, and a second sidewall 226g. The bottom portion 226c is a plate-shaped member disposed below the first blade member 221, the second blade member 224, the cleaning fluid roller 222, and the water roller 223, and includes holes h1, h2, h3, and h4 through which fluid is allowed to pass. The holes h1 to h4 are formed in positions corresponding to the positions of the first blade member 221, the cleaning fluid roller 222, the water roller 223, and the second blade member 224, respectively. The sidewall 226d on the first blade member side is disposed on the frontward of the first blade member 221 in the moving direction A1 (i.e., on the right side in FIG. 4), and a first fixing member 226i for fixing the first blade member 221 is disposed on the sidewall 226d on the first blade member side. The upper position of the first fixing member 226i is disposed to be lower than that of the sidewall 226d on the first blade member side, and thus the ink scraped away by the first blade member 221 is prevented from easily spilling out of the casing 226. The sidewall 226e on the second blade member side is disposed on the leftward of the second blade member 224 in FIG. 4, and a second fixing member 226j for fixing the second blade member 224 is disposed on the sidewall 226e on the second blade member side. The upper position of the second fixing member 226j is disposed to be lower than that of the sidewall 226e on the second blade member side, and thus the water, the cleaning fluid, and the ink scraped by the second blade member 224 is prevented from easily spilling out of the casing 226. The first sidewall 226f is disposed to connect an end of the sidewall 226 on the first blade member side and an end of the sidewall 226e on the second blade member side, and is provided with holes to which a pipe for supplying water from the water tank 223d to the water roller 223 and a pipe for supplying cleaning fluid from the cleaning fluid tank 222d to the cleaning fluid roller 222 are allowed to be connected. In addition, the second sidewall 226g is disposed to face the first sidewall 226f, and supports the water roller rotation shaft 223a and the cleaning fluid roller rotation shaft 222a together with the first sidewall 226f. The waste collected space 226b is disposed below the member arrangement part 226a, and temporarily accommodates the water, the ink, and the cleaning fluid, which pass through the holes h1 to h4 formed in the bottom portion 226c. In addition, the waste collected space 226b is connected to the used ink tank 226k. Note that the water tank 223d, the cleaning fluid tank 222d, and the used ink tank 226k are detachably/reattachably attached to the opposite side from the side on which the cleaning device 22 of a moving support member 85 to be described, and the cleaning device 22 is arranged on the top surface of the moving support member 85 and tanks are arranged on the reverse surface of the moving support member 85.

The moving mechanism 8 illustrated in FIG. 5 serves to move the cleaning device 22 in the longitudinal direction of the inkjet heads 21. Note that FIG. 5 is an overall top view simply illustrating a configuration of the moving mechanism 8. The moving mechanism 8 includes a pair of rail members 81 and 82, a pair of sliders 83 and 84, a moving support member 85, a plurality of pulleys 86a to 86e, a driving motor 87, and a frame (not illustrated in the figure) supporting these members.

The pair of rail members 81 and 82 are elongated members extending in a front-to-rear direction, and are parallely-disposed to be spaced apart in the horizontal direction.

The pair of sliders 83 and 84 are disposed to be allowed to slide along the rail members 81 and 82, respectively.

The moving support member 85 is formed by bending a plate member, and is disposed to bridge between the pair of rail members 81 and 82. The moving support member 85 is fixed to the pair of sliders 83 and 84, and moves back and forth (i.e., Arrow A1 direction and Arrow A2 direction) when the sliders 83 and 84 move along the rail members 81 and 82. A plurality of cleaning devices 22 is fixed on the front portion of the upper surface of the moving support member 85. In addition, a plurality of cap members 89 is provided on the backward of the cleaning devices 22, and corresponds to the ink discharge surfaces 212 of the inkjet heads 21. Note that in FIG. 5, only one of the cap members is given numeral 89, and the numbering of the rest of the cap members is omitted but are referenced using the same numeral. The cap members 89 cap the ink discharge surface 212 during the standby mode. With this configuration, it is possible to prevent the ink from drying out and deteriorating.

The plurality of pulleys 86a to 86e (i.e., first to fifth pulleys 86a to 86e) are rotatably disposed, respectively. The first and second pulleys 86a and 86b are disposed frontward and rearward of the rail member 81, respectively, such that the rail member 81 is interposed between them. A belt 88a is wound around the first and second pulleys 86a and 86b. One end of the belt 88a is fixed to the front end of the slider 83, and the other end of the belt 88a is fixed to the rear end of the slider 83. The third and fourth pulleys 86c and 86d are disposed frontward and rearward of the rail member 82, respectively, such that the rail member 82 is interposed between them. A belt 88b is wound around the third and fourth pulleys 86c and 86d. One end of the belt 88b is fixed to the front end of the slider 84, and the other end of the belt 88b is fixed to the rear end of the slider 84. In addition, the third pulley 86c is rotary-driven by the driving motor 87. Rotation of the driving motor 87 is transmitted to the fifth pulley 86e through a gear (not illustrated in the figure) that is rotary-driven by the driving motor 87, and the fifth pulley 86e rotates in the opposite direction from the third pulley 86c. An endless belt 88c is wound around the first and fifth pulleys 86a and 86e.

In the moving mechanism 8, when the third pulley 86c is rotary-driven in the counterclockwise direction in FIG. 5 by means of the driving motor 87, the belt 88b is driven and the slider 84 moves forward. In addition, at the same time as this, when the fifth pulley 86e is rotary-driven in the clockwise direction, the endless belt 88c and the belt 88a are driven, and thus the slider 83 moves forward. Accordingly, the cleaning device 22 as well as the moving support member 85 move forward (i.e., Arrow A1 direction). Note that the moving support member 85 and the cleaning device 22 move backward (i.e., Arrow A2 direction) when the driving motor 87 is driven in a direction opposite from the above case.

### 1-3. Operation

A printing operation will be hereinafter described in detail.

When the image information is transmitted from an external computer (not illustrated in the figures) connected to the inkjet printer 1, a sheet of paper as a recording media is conveyed from the paper loading unit 3 to the image forming unit 2 via the paper conveyor unit 4. Specifically, the sheet of paper is conveyed to the paper conveyor belt 42. When the sheet of paper is conveyed on the paper conveyor belt 42, ink is jetted from the inkjet heads 21 and an image is formed on the sheet of paper. After the image is formed on the sheet of paper, the sheet of paper is conveyed to the paper discharge unit 5 by way of the paper conveyor unit 4, and is discharged outside from the discharge unit 5. In this way, the printing operation is completed. Note that the elevation device 7 keeps the paper conveyor belt 42 in the moving-up condition illustrated in FIG. 1 during the above printing operation. Then, after the printing operation is performed with respect to predetermined sheets of paper, a cleaning operation is performed with respect to the inkjet heads 21. Here, the elevation device 7 moves the paper conveyor belt 42 down to a retracted position illustrated in FIG. 2.

Next, a cleaning operation of the ink discharge surface 2121 of the inkjet head 21 will be hereinafter explained in detail.

When a cleaning operation is performed with respect to the ink discharge surface 212 of the inkjet head 21, the moving mechanism 8 moves the cleaning device 22 in the longitudinal direction from the position where the first blade member 221 makes contact with one end portion of the ink discharge surface 212 in a longitudinal direction. Note that before the cleaning operation is started, the cleaning device 22 is retracted to the backward of the inkjet heads 21 (see FIG. 5), and moves forward when the cleaning operation is started. Thus, the casing 226 is caused to move to the other end portion of the ink discharge surface 212 in the longitudinal direction. During the movement, the first blade member 221, the cleaning fluid roller 222, the water roller 223, and the second blade member 224 sequentially make contact with the ink discharge surface 212.

Here, the ink adhering to the ink discharge surface 212 is scraped away by the first blade member 221. This step is hereinafter referred to as “scraping-away-ink step.” Note that the ink scraped away by the first blade member 221 is discharged through the hole h1.

Then, the cleaning fluid roller 222 rotates and slides with a portion of the ink discharge surface 212 in which the adhering ink has been already scraped away by the first blade member 221, and thus the portion of the ink discharge surface 212 is cleaned with cleaning fluid. This step is hereinafter referred to as “cleaning step with cleaning fluid.” The portion of the second porous member 222b of the cleaning fluid roller 222, which makes contact with the ink discharge surface 212, moves and makes contact with the regulation plate 225a when the second porous member 222b rotates. Accordingly, the cleaning fluid that includes the ink scraped away from the ink discharge surface 212 is squeezed out of the second porous member 222b. The squeezed-out cleaning fluid is discharged through the hole h2.

Furthermore, the water roller 223 rotates and slides with a portion of the ink discharge surface 212 which has been already cleaned with the cleaning fluid, and thus the portion of the ink discharge surface 212 is cleaned with water. This step is hereinafter referred to as “cleaning step with water.” The portion of the first porous member 223b of the water roller 223, which makes contact with the ink discharge surface 212, moves and makes contact with the regulation plate 225b when the first porous member 223b rotates. Accordingly, the water that includes the ink and the cleaning fluid scraped away from the ink discharge surface 212 is squeezed out of the first porous member 223b. The squeezed-out cleaning water is discharged through the hole h2.

After this, the fluid (e.g., ink, water, and cleaning fluid) adhering to the ink discharge surface 212 of the ink discharge portion 211 is scraped away by the second blade member 224. This step is hereinafter referred to as “scraping-away-fluid step.” The fluid including ink, cleaning fluid, and water, which is scraped away by the second blade member 224, is discharged through the hole h4.

Note that during the cleaning operation performed by the cleaning device 22, the elevation device 7 keeps the paper conveyor belt 42 in the moving-down condition illustrated in FIG. 2.

Here, the ink adhering to the ink discharge surface 212 is scraped away by the first blade member 221 before the ink discharge surface 212 is cleaned with cleaning fluid and water. Therefore, it is possible to prevent cleaning efficiency from being decreased when the amount of ink discharged from the ink discharge portion 211 is increased. In addition, the ink discharge surface 212 is cleaned with cleaning fluid, and accordingly it will be easy to clean it and it is also possible to clean it even when a resin-coated pigment is used as the ink. Furthermore, the ink discharge surface 212 is cleaned with water after it is cleaned with cleaning fluid, and accordingly it is possible to prevent the cleaning fluid from adhering to it and it is also possible to prevent reduction in water-shedding property of the ink discharge surface 212, which is caused by the adhering cleaning fluid.

### 2. Second Embodiment

### 2-1. Cleaning Device Configuration

The overall configuration of an inkjet printer of the second embodiment is the same or similar to that of the first embodiment, but the configuration of the cleaning device in accordance with the second embodiment is different from that in accordance with the first embodiment. Therefore, only the configuration of the cleaning device in accordance with the second embodiment will be hereinafter explained in detail.

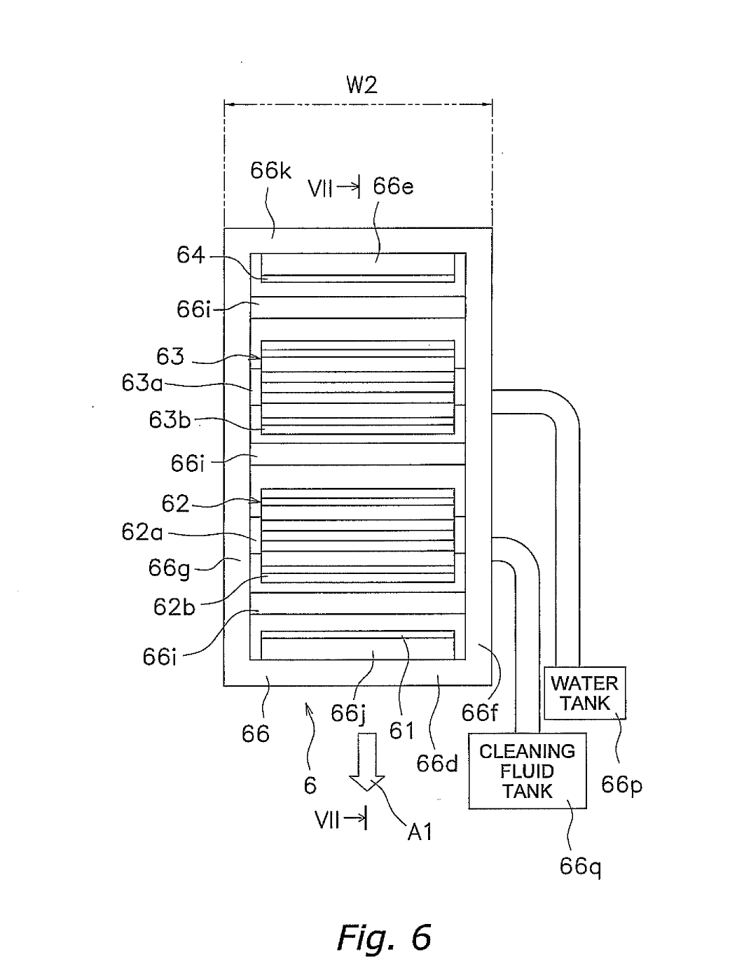

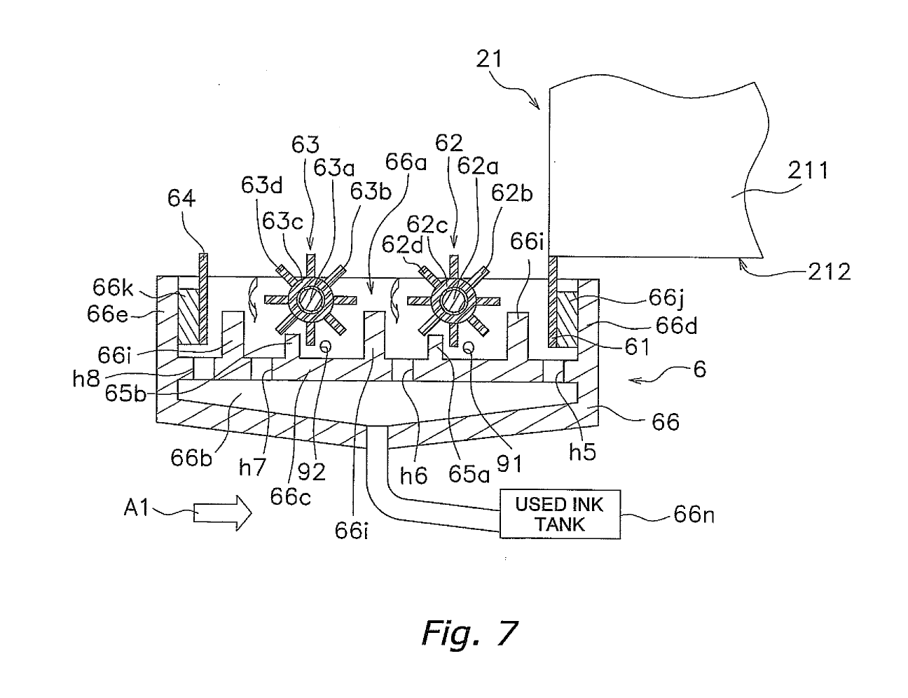

FIGS. 6 and 7 are overall diagrams of a cleaning device in accordance with the second embodiment (hereinafter referred to as a second cleaning device 6). More specifically, FIG. 6 is a top view of the second cleaning device 6, and FIG. 7 is a lateral cross-sectional view of the second cleaning device 6. As illustrated in FIG. 6, the second cleaning device 6 serves to clean the ink discharge surface 212, and is configured to have the width W2 (i.e., length in a direction perpendicular to the image illustrated in FIG. 7) that is larger than the width of the inkjet heads 21 (i.e., length in the direction perpendicular to the image illustrated in FIG. 7). In addition, the second cleaning device 6 is provided to correspond to each of the inkjet heads 21, and is connected to a used ink tank 66n illustrated in FIG. 7. Furthermore, the second cleaning device 6 is caused to move along the ink discharge surface 212 in an Arrow A1 direction in FIG. 7 by a moving mechanism that is the same as the moving mechanism explained in the first embodiment, and includes a third blade member 61, a first elastic gear 62, a second elastic gear 63, a fourth blade member 64, a regulation plate 65a, a regulation plate 65b, and a second casing 66.

The third blade member 61 scrapes away the ink adhering to the ink discharge surface 212, and is a plate-shaped member formed to extend in a direction (i.e., direction perpendicular to the image illustrated in FIG. 7). The third blade member 61 is formed such that its length perpendicular to the image illustrated in FIG. 7 is approximately the same as the length of the ink discharge surface 212 in the shorter direction. The third blade member 61 is disposed on an end of the second casing 66, and the upper tip of the third blade member 61 is disposed at a position slightly higher than the position of the ink discharge surface 212. In addition, the third blade member 61 is made of an elastically deformable substance such as ethylene propylene diene monomer (EPDM) and fluoro rubber.

The first elastic gear 62 serves to clean the ink discharge surface 212 with cleaning fluid, and is disposed leftward of the third blade member 61 in FIG. 7. In other words, the first elastic gear 62 is arranged sequentially next to the third blade member 61 in a moving direction A1 of the second casing 66. The first elastic gear 62 is formed such that its length perpendicular to the image illustrated in FIG. 7 is approximately the same as the length of the ink discharge surface 212 in the shorter direction. In addition, the first elastic gear 62 includes a first rotation shaft 62a and a first elastic member 62b. The first rotation shaft 62a is formed to extend in a direction perpendicular to the image illustrated in FIG. 7, and is secured to the second casing 66. The first elastic member 62b includes a tubular member 62c that is disposed to wind around the first rotation shaft 62a and gear tooth portions 62d that are radially formed to extend from the surface of the tubular member 62c. The gear tooth portions 62d are provided with porous members such as a sponge, and are capable of absorbing the cleaning fluid. In addition, the first elastic member 62b is configured to be disposed such that the highest position thereof is arranged to be approximately the same as the position of the upper tip of the third blade member 61. The first elastic member 62b is rotatably disposed with respect to the first rotation shaft 62a, and rotates in the counterclockwise direction in FIG. 7 when the second cleaning device 6 moves and thus the gear tooth portions 62d make contact with the ink discharge surface 212.

The second elastic gear 63 serves to clean the ink discharge surface 212 with water, and is disposed on the rearward of the first elastic gear 62 in the moving direction A1 (i.e., left side in FIG. 7). In other words, the second elastic gear 63 is arranged sequentially next to the first elastic gear 62 in the moving direction A1 of the second casing 66. The second elastic gear 63 is formed such that its length perpendicular to the image illustrated in FIG. 7 is approximately the same as the length of the ink discharge surface 212 in the shorter direction. In addition, the second elastic gear 63 includes a second rotation shaft 63a and a second elastic member 63b. The second rotation shaft 63a is formed to extend in a direction perpendicular to the image illustrated in FIG. 7, and is secured to the second casing 66. The second elastic member 63b includes a tubular member 63c that is disposed to wind around the second rotation shaft 63a and gear tooth portions 63d that are radially formed to extend from the surface of the tubular member 63c. The gear tooth portions 63d are provided with porous members such as a sponge, and are capable of absorbing water. In addition, the second elastic member 63b is configured to be disposed such that the highest position thereof is arranged to be approximately the same as the position of the upper tip of the third blade member 61. The second elastic member 63b is rotatably disposed with respect to the second rotation shaft 63a, and rotates in the counterclockwise direction in FIG. 7 when the second cleaning device 6 moves and thus the gear tooth portions 63d make contact with the ink discharge surface 212.

The fourth blade member 64 scrapes away the fluid (e.g., ink, water, and cleaning fluid) adhering to the ink discharge surface 212, and is a plate-shaped member formed to extend in a direction (i.e., direction perpendicular to the image illustrated in FIG. 7). The fourth blade member 64 is disposed on a lateral end portion of the second casing 66 that is opposed to the lateral end portion on the third blade member 61 side, and the upper tip of the fourth blade member 64 is disposed at a position slightly higher than the position of the ink discharge surface 212. In addition, the fourth blade member 64 is made of an elastically deformable substance such as ethylene propylene diene monomer (EPDM) and fluoro rubber.

The regulation plate 65a and the regulation plate 65b are plate-shape members formed to protrude upward from a bottom portion 66c of the second casing 66, and are arranged to make contact with the gear tooth portions 62d of the first elastic gear 62 and the gear tooth portions 63d of the second elastic gear 63, respectively. The regulation plate 65a makes contact with and presses the gear tooth portions 62d when the first elastic gear 62 rotates. On the other hand, the regulation plate 65b makes contact with and presses the gear tooth portions 63d when the second elastic gear 63 rotates. Thus, the regulation plates 65a and 65b are capable of squeezing out the cleaning fluid and the water that are absorbed in the gear tooth portions 62d and 63d, respectively.

The second casing 66 is a member supporting the third blade member 61, the first elastic gear 62, the second elastic gear 63, the fourth blade member 64, the regulation plate 65a and the regulation plate 65b, and includes a member arrangement part 66a and a waste collected space 66b. Here, members such as the third blade member 61 and the first elastic gear 62 are arranged in the member arrangement part 66a, and wasted fluid is collected in the waste collected space 66b. The member arrangement pan 66a includes a bottom portion 66c, a sidewall 66d on the third blade member side, a sidewall 66e on the fourth blade member side, a first sidewall 66f, and a second sidewall 66g. The bottom portion 66c is a plate-shaped member disposed below the third blade member 61, the fourth blade member 64, the first elastic gear 62, and the second elastic gear 63, and holes h5 to h8 through which fluid is allowed to pass are formed in the bottom portion 66c. The holes h5 to h8 are arranged in positions corresponding to the positions of the third blade member 61, the first elastic gear 62, the second elastic gear 63, and the fourth blade member 64, respectively. Furthermore, protruding partitions 66i are formed on the bottom portion 66c, and divide the space above the bottom surface 66c into a plurality of spaces: a space on which the third blade member 61 is disposed, a space on which the first elastic gear 62 is disposed, a space on which the second elastic gear 63 is disposed, and a space on which a fourth blade member 64 is disposed. The sidewall 66d on the third blade member side is disposed on the frontward of the third blade member 61 in the moving direction A1 (i.e., on the right side in FIG. 7), and a third fixing member 66j for fixing the third blade member 61 is disposed on the sidewall 66d on the third blade member side. The upper position of the third fixing member 66j is disposed to be lower than that of the sidewall 66d on the third blade member side, and thus the ink scraped by the third blade member 61 is prevented from easily spilling out of the second casing 66. The sidewall 66e on the fourth blade member side is disposed on the rearward of the fourth blade member 64 in the moving direction A1 (i.e., on the left side in FIG. 7), and a fourth fixing member 66k for fixing the fourth blade member 64 is disposed on the sidewall 66e on the fourth blade member side. The upper position of the fourth fixing member 66k is disposed to be lower than that of the sidewall 66e on the fourth blade member side, and thus the water, the cleaning fluid, and the ink scraped by the fourth blade member 64 is prevented from easily spilling out of the second casing 66. The first sidewall 66f is disposed to connect an end of the sidewall 66d on the third blade member side and an end of the sidewall 66e on the fourth blade member side, and is provided with a hole 92 to which a pipe capable of supplying water from a water tank 66p to the second elastic gear 63 is connected, and a hole 91 to which a pipe capable of supplying cleaning fluid from a cleaning fluid tank 66q to the first elastic gear 62 is connected. The cleaning fluid is supplied through the hole 91, and water is supplied through the hole 92. In addition, the second sidewall 66g is disposed to face the first sidewall 66f, and supports the first and second elastic gears 62 and 63 together with the first sidewall 66f. The waste collected space 66b is disposed below the member arrangement part 66a, and temporarily accommodates the water, the ink, and the cleaning fluid, which pass through the holes h5 to h8 formed in the bottom portion 66c. In addition, the waste collected space 66b is connected to the used ink tank 66n.

### 2-2. Operation

A printing operation in accordance with the second embodiment of the present invention is the same or similar to that in accordance with the first embodiment of the present invention. Therefore, only a cleaning operation performed for the ink discharge surface 212 will be hereinafter explained in detail.

When a cleaning operation is performed with respect to the ink discharge surface 212 of the inkjet head 21, the second casing 66 is caused to move in the rightward direction in FIG. 7 (i.e., Arrow A1 direction) from the position where the third blade member 61 makes contact with an end of the ink discharge surface 212 in the longitudinal direction so as to reach the other end of the ink discharge surface 212 in the longitudinal direction. During the movement, the third blade member 61, the first elastic gear 62, the second elastic gear 63, and the fourth blade member 64 sequentially make contact with the ink discharge surface 212.

Here, the ink adhering to the ink discharge surface 212 is scraped away by the third blade member 61 (i.e., scraping-away-ink step). Note that the ink scraped away by the third blade member 61 is discharged through the hole h5.

Then, the first elastic gear 62 rotates and slides with a portion of the ink discharge surface 212 in which the adhering ink has been already scraped away by the third blade member 61, and thus the portion of the ink discharge surface 212 is cleaned with cleaning fluid (i.e., cleaning step with cleaning fluid). Here, the cleaning fluid supplied through the hole 91 is absorbed by the first elastic gear 62, and a portion of the first elastic gear 62 that includes the cleaning fluid rotationally moves and makes contact with the ink discharge surface 212. Thus, the ink discharge surface 212 is cleaned. The cleaning fluid that includes ink as a result of cleaning of the ink discharge surface 212 is squeezed out of the first elastic gear 62 when the first elastic gear 62 further rotates and makes contact with the regulation plate 75a, and is then discharged through the hole h6. Here, the cleaning fluid excessively supplied through the hole 91 is also discharged through the hole h6. In order to reduce the wasteful amount of cleaning fluid, a sensor for detecting the fluid level of the cleaning fluid to be stored may be provided, and the amount of the cleaning fluid to be supplied may be controlled based on the detected fluid level.

Next, the second elastic gear 63 rotates and slides with a portion of the ink discharge surface 212 which has been already cleaned with cleaning fluid, and thus the portion of the ink discharge surface 212 is cleaned with water (i.e., cleaning step with water). Here, the water supplied through the hole 92 is absorbed by the second elastic gear 63, and the portion of the second elastic gear 63 that includes water rotationally moves and makes contact with the ink discharge surface 212. Thus, the ink discharge surface 212 is cleaned. The water that includes ink and cleaning fluid as a result of cleaning of the ink discharge surface 212 is squeezed out of the second elastic gear 63 when the second elastic gear 63 further rotates and makes contact with the regulation plate 65b, and is then discharged through the hole h7. Here, the water excessively supplied through the hole 92 is also discharged through the hole h7. In order to reduce the wasteful amount of water, a sensor for detecting the level of water to be stored may be provided, and the amount of water to be supplied may be controlled based on the detected water level.

After this, the fluid (e.g., ink, water, and cleaning fluid) adhering to the ink discharge surface 212 of the ink discharge portion 211 is scraped away by the fourth blade member 64 (i.e., scraping-away-fluid step). Note that the ink scraped away by the fourth blade member 64 is discharged through the hole h8.

Here, the ink adhering to the ink discharge surface 212 is scraped away by the third blade member 61 before the ink discharge surface 212 is cleaned with cleaning fluid and water. Therefore, it is possible to prevent cleaning efficiency from being decreased when the amount of ink discharged from the ink discharge portion 211 is increased. In addition, the ink discharge surface 212 is cleaned with cleaning fluid, and accordingly it will be easy to clean the ink discharge surface 212 and it is also possible to clean it even when a resin-coated pigment is used as the ink. Furthermore, the ink discharge surface 212 is cleaned with water after it is cleaned with cleaning fluid, and accordingly it is possible to prevent the cleaning fluid from adhering to it and it is also possible to prevent reduction in water-shedding property of the ink discharge surface 212, which is caused by the adhering cleaning fluid.

### 3. Alternative Embodiments

(a) In the above described embodiments, a resin-coated pigment is used as the ink. However, the type of ink is not limited to this in alternative embodiments of the present invention. For example, a dye (not including a resin) or the like may be used as the ink. In this case, a cleaning step with cleaning fluid may not be necessarily performed.

(b) In addition, in the above described embodiments, a cleaning operation is performed by the cleaning device. However, the cleaning operation is not limited to this in alternative embodiments of the present invention. For example, each step of the cleaning operation may be performed by each of members. More specifically, an alternative embodiment of the present invention may be configured such that the ink adhering to the ink discharge surface is scraped away by the blade member, and the ink discharge surface is cleaned with cleaning fluid and water, and then fluid adhering to the ink discharge surface (i.e., ink, water, and cleaning fluid) is scraped away by the blade member.

(c) The configuration of the moving mechanism for moving the cleaning device is not limited to and may be different from that of the above described embodiments.

(d) The cleaning step with cleaning fluid to be performed by the cleaning fluid roller 222 or the first elastic gear 62 in the above described embodiments may be omitted. In this case, it is also possible to clean efficiently the ink discharge surface 212 by way of the scraping-away-ink step, the cleaning step with water, and the scraping-away-fluid step.

(e) In the above embodiments, an image is formed on a sheet of paper. However, the above described cleaning device may be applied to an image forming device that forms an image on media other than a paper. It is also possible to apply the present invention to an image forming device including an image forming unit, a paper loading unit 3, and a paper conveyor unit 4, all of which are differently configured from those in the above embodiments.

### General Interpretation

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A method of cleaning an ink discharge portion of an image forming device, the image forming device being configured to form an image on media by discharging an ink on the media by the ink discharge portion, the ink discharge portion being formed to extend in a direction, comprising:
scraping away an ink adhering to a surface of the ink discharge portion;
cleaning the surface of the ink discharge portion with water; and
scraping away fluid adhering to the surface of the ink discharge portion after the ink discharge portion is cleaned with water.

2. The method according to claim 1, further comprising
cleaning the ink discharge portion with a cleaning fluid after the ink adhering to the ink discharge portion is scraped away.

3. The method according to claim 2, wherein the cleaning fluid is a fluid mainly including polyhydric alcohol and surface active agent.

4. The method according to claim 1, wherein a porous roller having a surface made of a porous member is used in cleaning with water.

5. The method according to claim 4, wherein cleaning the ink discharge portion with water is accomplished by moving the porous roller while the water is absorbed in the porous roller and the porous roller makes contact with the ink discharge portion.

6. The method according to claim 2, wherein a porous roller with a surface made of a porous member is used in cleaning with cleaning fluid.

7. The method according to claim 6, wherein cleaning the ink discharge portion with cleaning fluid is accomplished by moving the porous roller while the cleaning fluid is absorbed in the porous roller and the porous roller makes contact with the ink discharge portion.

8. The method according to claim 1,
wherein the ink discharge portion includes a rectangular-shaped ink discharge surface, and
wherein scraping away the ink adhering to the surface of the ink discharge portion is done by disposing a blade member with the length that is approximately the same as the length of the shorter side of the rectangular-shaped ink discharge surface and moving the blade member in a longitudinal direction of the ink discharge surface.

9. The method according to claim 1, wherein the ink includes a resin-coated pigment.

10. A cleaning device for an ink discharge portion of an image forming device, the cleaning device movably provided in the image forming device, the image forming device being configured to form an image on media by discharging an ink on the media by the ink discharge portion, the ink discharge portion being formed to extend in a direction, the ink discharge portion including an ink discharge surface, the ink discharge surface being configured to discharge the ink, comprising:
a first blade member being configured to contact the ink discharge surface;
a water roller including a first porous member on the surface thereof, the first porous member being configured to absorb moisture;
a second blade member being configured to contact the ink discharge surface; and
a housing accommodating the first blade member, the water roller, and the second blade member such that the first blade member, the water roller, and the second blade member are sequentially arranged along a moving direction, the housing supporting the first blade member, the water roller, and the second blade member.

11. The cleaning device according to claim 10, further comprising
a cleaning fluid roller, the cleaning fluid roller being disposed between the water roller and the first blade member, the cleaning fluid roller including a second porous member on the surface thereof, the second porous member being capable of absorbing the cleaning fluid.

12. The cleaning device according to claim 10, wherein the water roller accommodates a water supplying member in the interior thereof, the water supplying member being configured to supply the water to the first porous member.

13. The cleaning device according to claim 11, wherein the cleaning fluid roller accommodates a cleaning fluid supplying member in the interior thereof, the cleaning fluid supplying member supplying the cleaning fluid to the second porous member.

14. An image forming device, comprising:
an image forming unit including an ink discharge portion, the ink discharge portion including an ink discharge surface, the ink discharge surface being configured to discharge ink, the image forming unit forming an image on media by discharging the ink on the media by the ink discharge portion;
a cleaning unit being movably disposed with respect to the ink discharge surface, the cleaning unit including
a first blade member being configured to contact the ink discharge surface,
a water roller including a first porous member on the surface thereof, the first porous member being configured to absorb moisture,
a second blade member being configured to contact the ink discharge surface, and
a housing accommodating the first blade member, the water roller, and the second blade member such that the first blade member, the water roller, and the second blade member are sequentially disposed along a moving direction, the housing supporting the first blade member, the water roller, and the second blade member; and
a moving mechanism being configured to move the cleaning unit along the ink discharge surface from the first blade member side.

15. The image forming device according to claim 14, further comprising
a cleaning fluid roller being disposed between the water roller and the first blade member, the cleaning fluid roller including a second porous member on the surface thereof the second porous member being configured to absorb cleaning fluid.

16. The image forming device according to claim 14, wherein the water roller accommodates a water supplying member in the interior thereof, the water supplying member being configured to supply water to the first porous member.

17. The image forming device according to claim 15, wherein the cleaning fluid roller accommodates a cleaning fluid supplying member in the interior thereof, the cleaning fluid supplying member supplying cleaning fluid to the second porous member.

18. The image forming device according to claim 15, wherein
the first and second porous members are cylindrically shaped and elastically deformable, and each is arranged on a hollow shaft having a slit.

19. The image forming device according to claim 18, wherein
the housings include first and second regulation plates, and the first and second porous members are respectively arranged to contact the first and second regulation plates to be compressed by the contact respectively to remove excess water and fluid.

20. The image forming device according to claim 15, wherein the water roller and the cleaning fluid roller each further include tubular members, the first and second porous members each include tooth portions that extend from the tubular members.
